(19) United States
(12) Patent Application Publication
(10) Pub. No.: US 2003/0033541 A1
(43) Pub. Date: Feb. 13, 2003

(54) Method and apparatus for detecting improper intrusions from a network into information systems

(75) Inventors: Ronald O?apos;Neal Edmark, Austin, TX (US); John Michael Garrison, Austin, TX (US); Gregory Hess, Austin, TX (US)

Correspondence Address: Jeffrey S. LaBaw, IBM Corporation, 11400 Burnet Rd., Austin, TX, 78758, US

(73) Assignee: INTERNATIONAL BUSINESS MACHINES CORPORATION, ARMONK, NY

(21) Appl. No.: 09/923,574

(22) Filed: Aug. 7, 2001

(51) Int. Cl. G06F 11/30

(52) U.S. Cl. 713/201

(57) ABSTRACT

The present invention is directed to an interceptor security server. The server receives incoming requests from a network and determines if they are valid or not. When the requests are valid, the server relays them to other computing devices that store the actual data. The other devices then relay the requested information to the server, which then passes it to the requesting party. When an invalid request is received, the server denies the request. In this manner, the server protects the associated other computing devices from harmful attacks, snooping requests, or other invalid network requests.

### FIELD OF THE INVENTION

The present invention relates to intercepting inappropriate requests over a network. In particular the invention relates to a dedicated web server that acts as an intrusion detection and foiling apparatus for a bank of network based resources.

### BACKGROUND OF THE INVENTION

In many systems a web server typically comprises a powerful computing device connected to the Internet or other network access. The other network access may include a local area network (LAN), wide area network (WAN), or many other different types of communication schemas. In a typical configuration, the server comprises electronic information that relates to the display and transmission of digital information over the network.

When a user requests access to a file or otherwise makes a request for some sort digital information over the electronic network, the server may dispense such files through the network connection. Typically, the server may store electronic documents and other files, such as audio, video, graphics, and text. When an entity requests access to such files through any one of a number of protocols, including, but not limited to, hypertext transfer protocol (HTTP), the server device processes such a request to transfer the electronic information over the web to the remote user.

The requesting entities normally comprise computer users having a network connection to the server through a computer containing a web browser. The web browser typically comprises software on the client's computer, which is capable of navigating a web of interconnected documents on the worldwide web. This allows a user to “surf” the network connection. As such, the user traverses from one site over the interconnected network to another, requesting digital information from many different sources.

Each time the user requests the information contained on one of many servers, a request is made of the particular web server by the web browser to move a copy of the documents or information over the network to the user's computer. In this manner a user seamlessly traverses through a maze of interconnected networks to different computing devices and/or files contained on those computing devices.

An ineligible person may “fool” a web server into downloading or moving documents or other files to the requesting client's computer that would not be obtainable by a typical user. Or, such a user may actively probe the server mechanism for weaknesses in security systems, searching for viable data. This viable data may be information stored on the servers, access to other servers, or passwords reflective of the entity operating the server.

Since many servers operate under one of a few types of operating systems, these servers typically have many commonly known or default names for directories, system files, or executables used in those directories. Since the distribution of information contained in unauthorized access to documents, and/or use of files accessible to an entity using a web server could be detrimental to the owner of the server, some typical techniques have been devised to alert the operator of the web server that such information has been requested or retrieved.

This alert is typically accomplished by the web server from which the information has been requested reading or examining the access logs and comparing the request previously granted to material contained in the list. Such a list is typically designated as a “signature file,” “list of signatures,” or “list of attack signatures.” In such a file, information includes inappropriate requests that would be detrimental to the server, the owner of the server, or others in connection with the server.

This list may include addresses of known hackers that the web server administrator has decided should no longer be serviced by the web server. Or, security parameters may involve placing various directories, and/or file names in such a protected list. In this manner, any requests to access certain data would be deemed an unauthorized attempt. In this case, the names of these off limits directories may be used as a means of detecting and refusing these requests for files contained in specific directories, thus keeping hackers from snooping around in sensitive areas.

Additionally, some web servers may have trap doors or bugs in the software code that is known to hackers. These trapdoors or bugs may have a property where a given code may allow the insertion of software code into the operating system on the web server. As such, the web server needs to provide some means for detecting such requests that specify specific hexadecimal file names.

Other deviant requests include the sending of “malformed” http requests to probe a web server for weaknesses in the software code implementation. In these cases, these malformed requests are designed to attack or crash the web server.

In the case of a powerful server, such repeated requests take time to process, even if they are granted or denied. Screening programs can be devised to shield the single server from attack or snooping activities. In the case of a single server, each deviant request takes time away from the server in which it could be processing proper requests. Thus, the server actually may be prevented through such security checking from processing normal requests. This is known as “thrashing.” In this case, the security checking and the normal operations of the server are mutually exclusive.

In this manner, the typical prior art does not allow for flexible processing schedules along with dealing with ever-changing security rejection issues. Many other problems and disadvantages of the prior art will become apparent to one skilled in the art after comparing such prior art with the present invention as described herein.

### SUMMARY OF THE INVENTION

Aspects of the invention are found in a proxy server for one or more servers that fields requests and makes security determinations based upon the request. If the request is deemed to be proper, the gateway or proxy server will pass such a request on to one or more co-servers to fulfill the request. When the co-server fulfills the request, the source server passes the requested information back to the proxy server, which then directs the information to the end user. In this manner, the functionality of the servers behind the proxy are not impinged in any way due to deviant request.

Additionally, the proxy server may be viewed as an interceptor server. The interceptor server serves to screen out unwanted and unneeded requests from the one or more shielded servers that it “protects.” It accomplishes this by looking at particular incoming requests, and attempting to identify those requests as improper requests. It accomlishes this by examining paramters associated with the request and the requested information, and comparing those indicia with a “rogue's gallery” of questionable type requests. This “rogue's gallery” can be a file-based list that checks the paramters of the incoming request with such things as: origination IP address, requested actions, requested information, or codes embedded within the request itself.

These indicia of improper requests will single out many improper requests prior to those requests being directed to the servers.

In this manner the interceptor server examines incoming requests before relaying such requests to the machine that the request will be implemented by. Additionally, the interceptor server may refuse any request considered to be inappropriate prior to the request accessing the source machine itself. In this manner the interceptor server may be configured to solely perform such screen functions efficiently and effectively. Thus, the protection functions that used to be shared with normal operational functions are now separated and performed more efficiently.

Additionally, the interceptor server acts to protect the server bank from such deviant requests as described above. Additionally, through common techniques, the existence of the source server may not be ascertainable, since the server returning the request will have the address information associated with the proxy server, rather than the server bank that it protects. Thus, the interceptor server both protects and serves to shield critical information from unauthorized access.

As such, an interceptor proxy request screener is envisioned. Other aspects, advantages and novel features of the present invention will become apparent from the detailed description of the invention when considered in conjunction with the accompanying drawings.

### DESCRIPTION OF THE DRAWINGS

FIG. 1 is a schematic block diagram of a network employing the invention.

FIG. 2 is a block diagram of an embodiment of the interceptor server of FIG. 1.

FIG. 3 is a flow diagram of a program that the interceptor server of FIG. 1 may employ in the invention.

### DETAILED DESCRIPTION

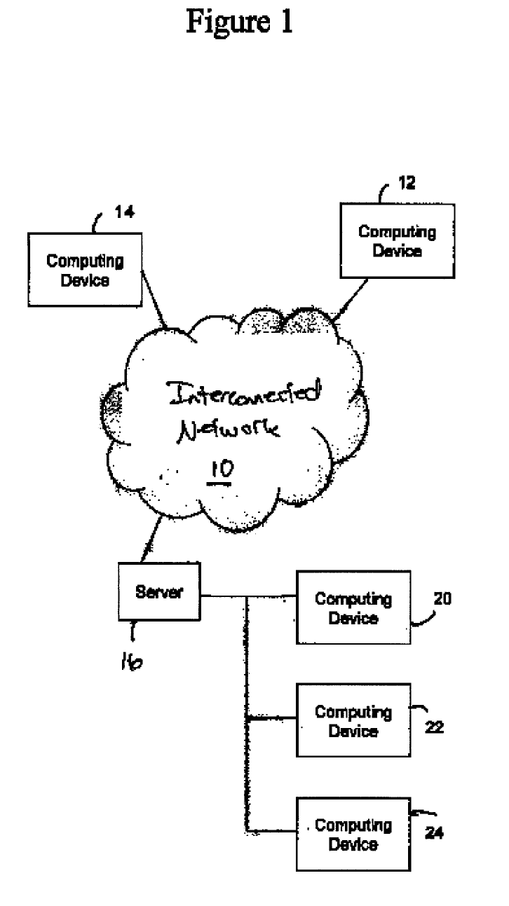

FIG. 1 is a schematic block diagram of a network employing the invention. An interconnected network 10 couples computing device 12 to computing device 14. Additionally, the interconnected network 10 couples the computing devices 12 and 14 to a server 16. A user who wishes to request information from the entity associated with the server 16 makes the request from any of the computing devices 12 or 14 attached to the interconnected network.

The interconnected network may comprise many forms and types using various protocols. The most typical example is the Internet, however, the interconnected network 10 may include such networks as a local area network (LAN), a wide area network (WAN), or any of a number of associated architectures. The connections between the computing devices 12, 14 and 16 to the interconnected network 10 may be hardwired connections governed by a TCP/IP protocol, or they may be covered by some sort of wireless network protocol.

A user at the computing device 12 makes a request of the server 16 for information ostensibly connected with the server 16. The server 16 intercepts a new request, and determines the validity of the request based on signature files contained within it. These signature files may compare their request for access, or operating purposes. As stated before, known IP addresses, known requesting IP addresses may be placed in the signature file, unauthorized directory requests may be placed in the signature file, or malformed requests or requests containing faulty execution segments may be placed in the signature file.

Or, other security provisions may be dynamically monitored, added, or changed. Thus, the security provisions need not be statically defined, but may be adapted to the network traffic itself. Whatever the mechanism, the server 16 can discriminate such security breaching for unauthorized requests through information contained within itself, or through information it ascertains.

The interceptor server need not act statically in the environment. For example, a single request from a “good” IP address may not trigger a reaction from the interceptor server. However, the context may change on the fly, and what may be a valid or non-deviant request in singleton mode may be deemed deviant in a changing context.

In an exemplary environment, a particular IP address requests a particular piece of information. This does not trigger the security file, and as such the request is granted. Assume, however, that the IP address starts to request a massive amount of data without letup. This is indicative of a “burrowing computer”, a “web spider” or “web robot”, a “web crawler”, a “web ant other (distributed cooperation robots)”, or other requests that rise to the level of looking for information in a suspicious manner in the aggregate. In this manner, the interceptor may change the context of the IP address to a deviant address.

In an alternative scenario, assume that a massive amount of requests flood the interceptor with requests for the same information, but from different IP addresses. This is indicative of a “denial of service” attack, and the interceptor server would change the context of the request for the particular information as being deviant.

As noted, the security list may contain parameter-based criteria that would spark such context determinative actions. This could include a maximum number of requests by a particular IP address in a particular time, a maximum number of refresh requests, or a maximum number of requests for a particular information. Additionally, the security list contains one or more indicia associated with requests that may flag such requests as improper. These include such hallmarks as: known rogue IP origination addresses, hexadecimal codes embedded in the request, requests for sensitive information or restricted access resources, or malformed HTTP requests.

Upon determining that a specific request is unauthorized, or that a series of requests has made the request unauthorized, the server 16 may do a number of things. First, it may simply deny the request to the requesting computer device. Or, the server 16 may deny the request and file such a request in a log for generation of future signature files. Or, in addition to denying the request, the server 16 may send a remote alert to an operator signifying the presence of some sort of unauthorized access attempt.

If the server determines that such a request is a valid request, the server then requests the requested information from any of the protected computing devices 20, 22, or 24. When the requested information is passed from the specific computer devices back to the interceptor server, it then relays the information to the requesting individual at the appropriate computing device over the interconnected network 10.

In this manner the server 16 can serve to channel and/or obfuscate the returned requests to and from the source servers. Additionally, the interceptor server 16 serves in a solo function as a gatekeeper to the information contained in the computing devices 20, 22, and 24.

As such, when improper requests from a user at one of the computing devices over the interconnected network is “deflected” from the server device 16 from the targeted attack, one of the computing devices 20, 22, or 24 is spared the effort of processing that request.

Thus, the system associated with the interceptor server may be thought of as an intrusion detection system. The intrusion detection system screens incoming requests for particular indicia that the request is an improper request. The screen may be for static items, such as IP addresses, requested resources, embedded codes, or malformed commands. Or, the indicia may be dynamic in nature, such as those that screen based on time of day, number of requests by a single IP address, or numbers of requests for one or more pieces of information.

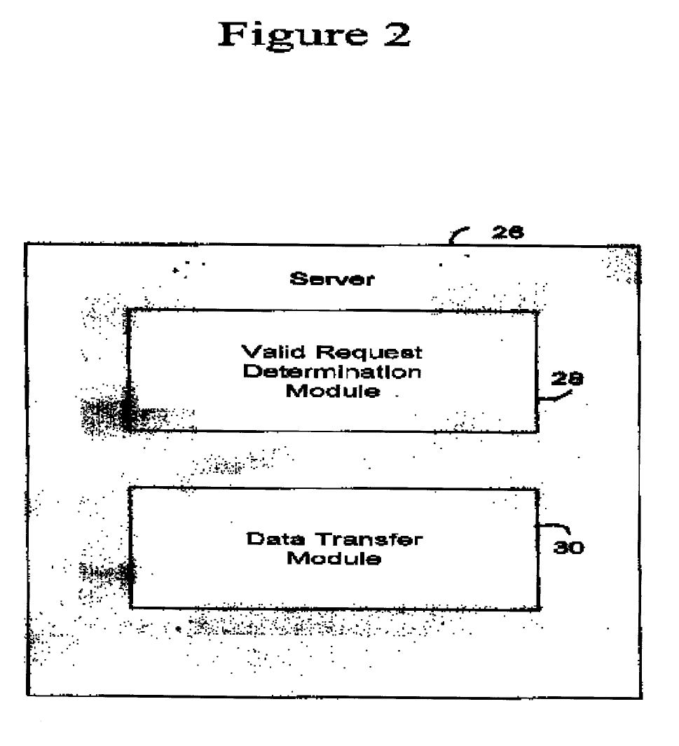

FIG. 2 is a block diagram of an embodiment of the interceptor server of FIG. 1. The interceptor server 26 contains a valid request determination software files 28 and a data transfer software 30. Upon receipt of a request from an external requesting device, the received request is compared in a valid request determination software 28.

If a determination is made that the request is invalid or otherwise unauthorized, the interceptor server 26 may do any one of the steps described above in relation to FIG. 1. Upon determining that the request is valid, the interceptor server 26 forwards such requests to the appropriate computing device containing such information. This is accomplished through the data transfer software. 30.

Next, when the information is received back from the appropriate data carrying computing device, the interceptor server 26 retransmits such information to the requesting device through the data transfer software. In this manner, the interceptor server 26 acts as a shield for the rest of the connected computing devices associated with the entity controlling the interceptor server 16. Additionally, the interceptor server serves to mask the true origination of the information as requested originally by the user. This masking serves as an additional function since a hacker or other entity can not truly ascertain precisely where in the system the actual information may reside, or other pertinent information about the end requested device.

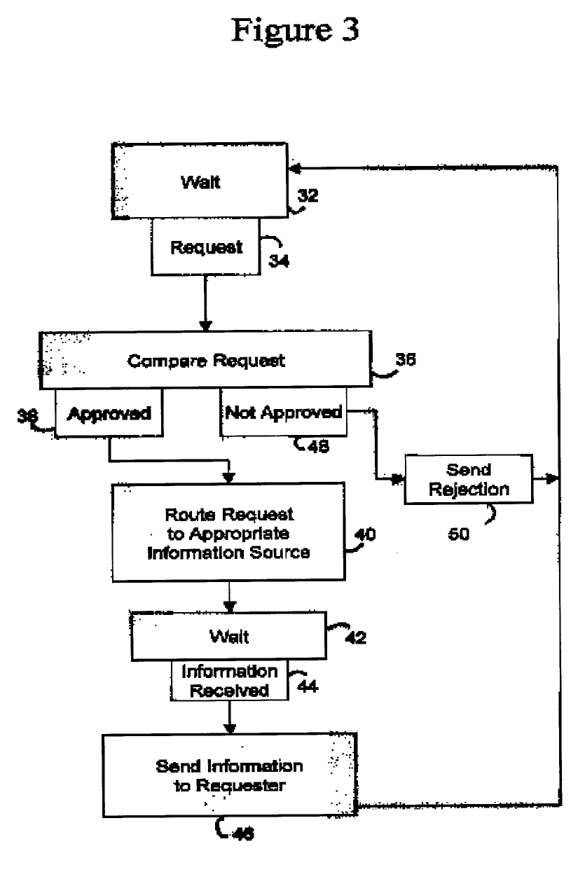

FIG. 3 is a flow diagram of a program that the interceptor server of FIG. 1 may employ in the invention. In a block 32, an interceptor server awaits reception of a request for information from an end user. In a block 34, such a request has arrived at the interceptor server. In a block 36, the interceptor server compares the incoming request with an attack signature file or other predetermined list of files and/or categories of files and/or combinations of characters that may be considered to be intrusive or otherwise inappropriate, as well as specific undesirable IP addresses.

In the block 38, the request is deemed to be appropriate, and is forwarded to the computing device containing the appropriate information in a block 40. In a block 42, the interceptor waits for the appropriate device to respond. In a block 44, the response has arrived, and in a block 46 the interceptor server transmits the returned information to the requesting user. In the block 46, it should be noted that the interceptor server may hide the true source of the requested information from the user since the interceptor server will be the final link in the transmission chain. The interceptor server then returns to the wait stage 32 for another request.

In a block 48, the interceptor server has determined that such an incoming request is inappropriate. The interceptor server then sends an appropriate rejection response in a block 50. Then, the interceptor server returns to the wait state in the block 32.

In should be noted in the block 50 that the interceptor server may initiate other actions, such as alarms and/or notifications to appropriate persons that such an intrusive act has been attempted. Additionally, the interceptor server may dynamically update the valid request determination based upon the numbers and types of requests made of it.

It should be noted that the present invention, the providing for isolation and examination of an incoming request in an attempt to determine security issues before taking any action to comply limits the likelihood of breaches or successful cyber attacks if an up to date signature file is used. Additionally, the interceptor server serves the added function of protecting the true location in a network sense of the underlying information bearing machines.

Thus, an architecture for implementing a proxy security screener server is described. It should be noted that such an architecture may be implemented with a computing device. The computing device may be a general purpose or specialized computing device. It should also be noted that the architecture may be implemented as software run on the computing device and within such components as magnetic media or computer memory associated with the computing device.

In view of the above detailed description of the present invention and associated drawings, other modifications and variations will now become apparent to those skilled in the art. It should also be apparent that such other modifications and variations may be effected without departing from the spirit and scope of the present invention as set forth in the claims which follow.

What is claimed is:

1. A server system that processes an incoming request for information from a user over network, the server system comprising:
one or more source servers that store information;
a first server, communicatively coupled to the one or more source servers and to the network; that receives the incoming request from the network; and
the first server testing the the incoming request for an indicia contained within the request that the request is not proper for the source servers to respond to the request, and passing the incoming request to the one or more source servers when the incoming request is valid.

2. The system of claim 1, the one or more source servers transmitting information to the first server in response to the incoming request; and
the first server retransmitting the information to the user.

3. The system of claim 1 wherein the first server does not pass the incoming request to the one or more source servers when the incoming request is an indicia that the request is not proper for the source servers to respond to the request.

4. The system of claim 1 wherein an incoming request is detemined to be not proper when the when the request is for access to a particular resource.

5. A computing system that preprocesses and monitors incoming requests for information from a user over network, the information stored on one or more source servers communicatively coupled to the computing system, the computing system comprising:
a network input port that receives the request;
a source server port, communicatively coupled to the one or more source servers, that transmits information to and from the source servers;
a intrusion detection mechanism communicatively coupled to the network input port;
the intrusion detection mechanism receiving the incoming request from the network and checking the the incoming request for indicia of an improper request from information associated with the incoming request;
the intrusion detection mechanism transmitting the incoming request to the one or more source servers when the indicia associated with the incoming request is valid.

6. The system of claim 5, the one or more source servers transmitting information to the source server port in response to the incoming request; and
the system retransmitting the information to the user.

7. The system of claim 5 wherein the intrusion detection mechanism does not pass the incoming request to the one or more source servers when the incoming request has an indicia that it is not proper.

8. The system of claim 5 wherein an incoming request has an indicia that it is not proper when requesting access to a particular resource.

9. A method for preprocessing an incoming request for information from a user over network, the information stored on one or more source servers communicatively coupled to a computing system, the method comprising:
receiving the request on the computing system;
determining if the incoming request is indicia of not being proper, the indicia associated with the incoming request;
selectively not transmitting the incoming request to the one or more source servers when the incoming request is contains indicia of not being proper.

10. The method of claim 9 wherein the step of determining is performed by a software resident on the computing system.

11. The method of claim 9 further comprising:
transmitting information from the one or more source servers to the computer system in response to the incoming request; and
the computing system retransmitting the information to the user.

12. The method of claim 9 wherein an incoming request is contains indicia of not being proper when requesting access to a particular resource.

13. A computer program product on a computer usable medium, the computer usable medium having a computer usable program embodied therein for preprocessing an incoming request for information from a user over network, the information stored on one or more source servers communicatively coupled to a computing system, the computer usable program including:
instructions for receiving the request on the computing system;
instructions for determining if the incoming request contains indicia of not being proper;
instructions for selectively transmitting the incoming request to the one or more source servers when the incoming request contains indicia of being proper.

14. The computer program product of claim 13 wherein the instructions for determining are performed by a software resident on the computing system.

15. The computer program product of claim 13 further comprising:
instructions for transmitting information from the one or more source servers to the computer system in response to the incoming request; and
the computing system having instructions for retransmitting the information to the user.

16. The computer program product of claim 13 wherein an incoming request is invalid when requesting access to a particular resource.

17. A server system that processes an incoming request for information from a user over network, the server system comprising:
one or more source servers that store information;
a first server, communicatively coupled to the one or more source servers and to the network; that receives the incoming request from the network; and
the first server detecting an intrusion of the incoming request in the context of prior requests and based on indicia of the incoming request being proper, such indicia being associated with the incoming request, and
the first server passing the incoming request to the one or more source servers when the indicia associated with the incoming request indicates that the incoming request is proper.

18. The server of claim 17, wherein the context of prior requests comprises requests for the same information.

19. The server of claim 17, wherein the context of prior requests comprises requests for different information from a common computing device coupled over the network.

20. The server of claim 17, wherein the context of prior requests is based on a number of requests for the same information.

21. The server of claim 17, wherein the context of prior requests is based on a number of requests from a particular IP address.

22. The server of claim 17, wherein the context of prior requests is based on a number of requests for information from a particular IP address in a particular amount of time.
